(19) United States
(12) Patent Application Publication
(10) Pub. No.: US 2003/0064737 A1
(43) Pub. Date: Apr. 3, 2003

(54) Method and apparatus for distortionless peak reduction

(76) Inventors: Patrik Eriksson, Kolmarden (SE); Stellan Carebo, Sundbyberg (SE); Ari Ghafouri, Sollentuna (SE); Thord Hyllander, Solna (SE); Peter Magnus Petersson, Jarfalla (SE)

Correspondence Address: NIXON & VANDERHYE P.C., 8th Floor, 1100 North Glebe Road, Arlington, VA, 22201-4714, US

(21) Appl. No.: 09/964,865

(22) Filed: Sep. 28, 2001

(51) Int. Cl. H04B 7/005

(52) U.S. Cl. 455/501; 455/67.3

(57) ABSTRACT

The present invention reduces the peak-to-average power ratio (PAR) of a signal while at the same time providing improved signal-to-noise-and-distortion and increased dynamic range. In the context of a transmitter, the PAR of an input signal is reduced so that one or more elements of a transmitter can be operated with increased dynamic range. However, the initial PAR is restored before the signal is transmitted thereby removing distortion generated as the result of the PAR reduction. The initial PAR is reduced in the digital domain, converted into the analog domain, and then restored in the analog domain.

### FIELD OF THE INVENTION

The present invention relates to reducing a signal peak-to-average ratio (PAR), and more particularly, to reducing the PAR of a signal without causing distortion.

### BACKGROUND AND SUMMARY OF THE INVENTION

In many applications, it is necessary to convert a digital signal to an analog equivalent where the analog signal is typically a voltage or current corresponding to the value of a digital word. The dynamic range of a digital-to-analog converter is determined by the size (number of bits) of the digital code range handled by the digital-to-analog converter. Dynamic range is often defined as the difference in decibels between the noise level and the level at which the output is saturated, i.e., the overload level. The cost of digital-to-analog converters increases as the code range increases to larger bit lengths. Although it is possible to achieve a desired dynamic range using a digital-to-analog converter with a small number of bits, an accompanying deterrent is a significant increase in quantization error, and thus, the accuracy of the analog-to-digital converter is reduced.

One example application of digital-to-analog converters is in multicarrier transmitters. A typical multicarrier data stream includes, for example, N independent baseband data streams, each representing a separate frequency channel. Each baseband data stream modulates its corresponding digital carrier signal. The N-modulated carriers are summed in the digital domain before being applied to a digital-to-analog converter which converts that multicarrier signal into the analog domain. The composite analog signal is frequency-up converted (one or several times), amplified, and filtered before being transmitted via an antenna.

A simplified block diagram of a multicarrier transmitter is shown in FIG. 1. N data streams 12A-12N are separately processed in corresponding signal processing blocks 14A-14N in which those processing operations are performed for example symbol mapping, pulse shaping, and power control. The processed baseband data streams are then quadrature modulated onto various frequency carriers fₗ-f_{N} using corresponding oscillators 18A-18N and mixers 16A-16N. The quadrature modulated information is summed at summer 20 into a single digital input stream converted in the digital-to-analog converter 22. The analog signal is frequency converted, filtered, and amplified, as indicated at block 24, before being transmitted over antenna 26.

The resulting composite signal generated by the digital summer 20 will generally have a high Peak-to-Average power ratio (PAR). The peak signal power of the multicarrier signal with M carriers can be defined as:

$${P}_{p e a k} = {M}^{2} {V}_{p e a k}^{2} \qquad ( 1 )$$

assuming M carrier all with a peak voltage of Vₚₑₐₖ and a reference resistance of 1 ohm. If the individual baseband signals are of constant envelope, the average signal power in the composite multicarrier signal is as follows:

$${P}_{a v e r a g e} = \frac{M {V}_{p e a k}^{2}}{2} \qquad ( 2 )$$

The peak-to-average ratio (PAR) reduces to

PAR=2M (3)

The expression used here for PAR refers to signal average power and not to envelope average power. The signal average power is 3 dB lower than the envelope average power due to the carrier frequency up conversion.

The scale of a digital-to-analog converter includes a range of digital codes from a zero analog level output code to a full scale (FS) or maximum level analog level output code. Since the peak-to-average power ratio (PAR) increases with the number of carriers, it is necessary to increase the amount of “back-off” from the full scale value in the digital-to-analog converter to ensure that the multicarrier signal is not clipped by the digital-to-analog converter or that the amplification stage 24 is not saturated. Clipping of the signal causes distortion both in-band and out-of-band during the time when the clipping event occurs. However, if the clipping event has a low probability, i.e., occurs only for a low fraction of the time, the clipping does not produce a very high average distortion power.

There are several different approaches to reducing the PAR of multicarrier signals. A first approach uses phasing of information-bearing carriers. By changing the phase of the individual carriers of a multicarrier signal relative to each other, peaks may be eliminated or avoided at summation. The phasing changes may be performed either by manipulation of the baseband data or by instantaneous phasing of digital local oscillators using the quadrature modulation stage. In a multicarrier modulation system which allows a transmitter to make phase changes in order to increase the PAR, a transmitter-receiver “handshake” is then needed to inform the receiver of the changes so that the receiver can compensate for them. Untfortunately, if the handshake is not a standardized procedure, equipment from different manufacturers will not be configured to perform the handshake. As a result, any baseband data manipulations or changes in carrier phase will result in bit errors, and hence, a degradation in system performance. To achieve a substantial reduction in PAR, the carrier phases must be changed frequently which may lead to an unacceptable increase in bit error rate, even in a system which uses an error correction coding scheme.

A second approach to reducing PAR of multicarrier signals uses anti-phase signals. One or more anti-phase signals are added to the multicarrier signal such that any peaks are suppressed below a predefined threshold. The anti-phase signal(s) may be added continuously in time, or only when the multicarrier signal exceeds the predefined threshold. Clipping of the multicarrier signal maybe considered a special case of anti-phase signal addition. The time domain, anti-phase signal is the part of the multicarrier signal that lies above the clipping level. In general, the anti-phase signal may be composed of any combination of narrowband and wideband signals, and may include in-band and/or out-of-band spectral content. Unused or out-of-band carriers may be used as anti-phase signals. A common limitation for wireless systems, however, is that the anti-phase signal may not be transmitted because of system requirements pertaining to spectral purity. Thus, many systems are limited to low level (and therefore inefficient) anti-phase signals, or to anti-phase signals outside of the transmit band which permits them to be filtered before transmission. The clipping resulting from the anti-phase signal addition generates a wideband spectrum of components harmonically related to the carriers including intermodulation and harmonic distortion. Although unused carrier frequencies may be used for transmission of anti-phase signals in some systems, transmission of unused carrier frequencies in cellular systems means that the interference level in the system increases, which causes degradation of system performance.

A third approach uses power control/reduction. Power control may be used to regulate the power level of each carrier so that the peak power is below a predefined threshold. Because power control is usually a linear operation, it does not cause distortion. However, while the power control is active, the average signal power is also reduced. Frequent power reduction, which would be necessary for a significant reduction in PAR, results in degraded system performance.

A fourth approach uses symbol coding. The symbols to be transmitted may be coded in different ways such that many code sequences with different PARs are generated. The sequence exhibiting the lowest PAR may then be selected for transmission. A drawback with coding is that the added redundant information reduces the effective user bit rate. Furthermore, both the transmitter and receiver must be capable of coding and decoding, respectively. This approach is not applicable to wireless cellular systems where only standardized coding schemes are permitted. In a Time Division Multiple Access (FDMA) system, a related approach is to rearrange the order of timeslots to be transmitted on each carrier so that the peak signal voltages are minimized. But such an approach requires that the receiver be informed about and responsive to the timeslot rearrangement.

The present invention provides a superior approach to reducing the Peak-to-Average power Ratio (PAR) of a signal which achieves a number of benefits including improved signal-to-noise-and-distortion ratio and increased dynamic range. In the context of a transmitter, the present invention may be used to reduce the PAR of an input signal so that one or more elements of the transmitter can be operated with increased dynamic range. However, because the initial PAR is restored before the signal is transmitted, distortion generated as a result of the PAR reduction is removed.

A signal having an initial PAR is processed so as to reduce its initial PAR in the digital domain. The reduced PAR digital signal is converted into the analog domain. The initial PAR is then restored from the reduced PAR signal in the analog domain, thereby removing distortion caused by the PAR reduction. The PAR reduction may preferably be accomplished using an anti-phase signal to offset peaks of the initial signal in the digital domain. The anti-phase may then be transformed into an in-phase signal and converted into the analog domain. The analog in-phase signal is combined with the reduced PAR analog signal to restore the initial PAR and remove the reduced PAR related distortion.

The PAR of the input signal may be reduced using any type of offsetting signal, i.e., the present invention is not limited to an anti-phase signal. The PAR of the input signal is reduced by the offsetting signal to produce a combined signal. The combined signal and offsetting signal may then be separately processed taking advantage of the reduced PAR of the input signal. Once those reduced PAR processing advantages have been obtained, the processed combined signal is combined with the processed offsetting signal to restore the PAR and remove any distortion caused by the PAR reduction.

In a preferred, example, and non-limiting embodiment of the present invention, first electronic circuitry receives a digital input signal and formulates an associated anti-phase signal. A first combiner combines the input and anti-phase signals to produce a peak-limited digital signal. A first digital-to-analog converter converts the peak-limited digital signal into a peak-limited analog signal. A second digital-to-analog converter converts the anti-phase digital signal into an anti-phase analog signal. A second combiner combines the peak-limited analog signal and the anti-phase analog signal. Before conversion to the second digital-to-analog converter, processing circuitry is provided to change a sign of the anti-phase signal or to invert the anti-phase signal into an in-phase signal. Preferably, the combining of the input and anti-phase digital signals limits the input signal peak value to a threshold associated with a range of the first digital-to-analog converter. The threshold corresponds to a full-scale range of the first digital-to-analog converter. As a result, the peak-limited analog signal does not contribute substantial quantization noise from the conversion performed in the first digital-to-analog converter to the combined analog signal. As a result, a dynamic range associated with the digital-to-analog conversion of the input signal using the first and second digital-to-analog converters is greater than using only a single digital-to-analog converter.

In other example embodiments, analog processing circuitry may perform analog processing on the combined analog signal or analog processing can be performed on both the peak-limited analog signal and the anti-phase analog signal before the combining. Additional digital analog converters can be used to convert the anti-phase digital signal into an anti-phase analog signal to accommodate larger PAR reductions.

### BRIEF DESCRIPTION OF THE DRAWINGS

The foregoing and other objects, features, and advantages of the invention will be apparent from the following description of preferred, non-limiting example embodiments, as well as illustrated in the accompanying drawings. The drawings are not to scale, emphasis instead being placed upon illustrating the principles of the invention.

FIG. 1 is a function block diagram of a multicarrier transmitter;

FIG. 2 is a flowchart diagram illustrating procedures in accordance with one example embodiment of the present invention;

FIG. 3 is a function block diagram of a preferred, example, non-limiting embodiment of the present invention;

FIGS. 4A-4C show example signal waveforms at various points in the function block diagram of FIG. 3;

FIG. 5 is a flowchart diagram illustrating procedures in accordance with a PAR reduction routine in accordance with another example embodiment of the present invention; and

FIGS. 6-9 illustrate various non-limiting and example embodiments of the present invention.

### DETAILED DESCRIPTION

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details. In some instances, detailed descriptions of well-known methods, interfaces, devices and processing techniques are omitted so as not to obscure the description of the present invention with unnecessary detail. Moreover, individual function blocks are shown in some of the figures. Those skilled in the art will appreciate that the functions may be implemented using individual hardware circuitry, using software functioning in conjunction with a suitably programmed digital microprocessor or general purpose computer, using an Application Specific Integrated Circuit (ASIC), and/or using one or more Digital Signal Processors (DSPs).

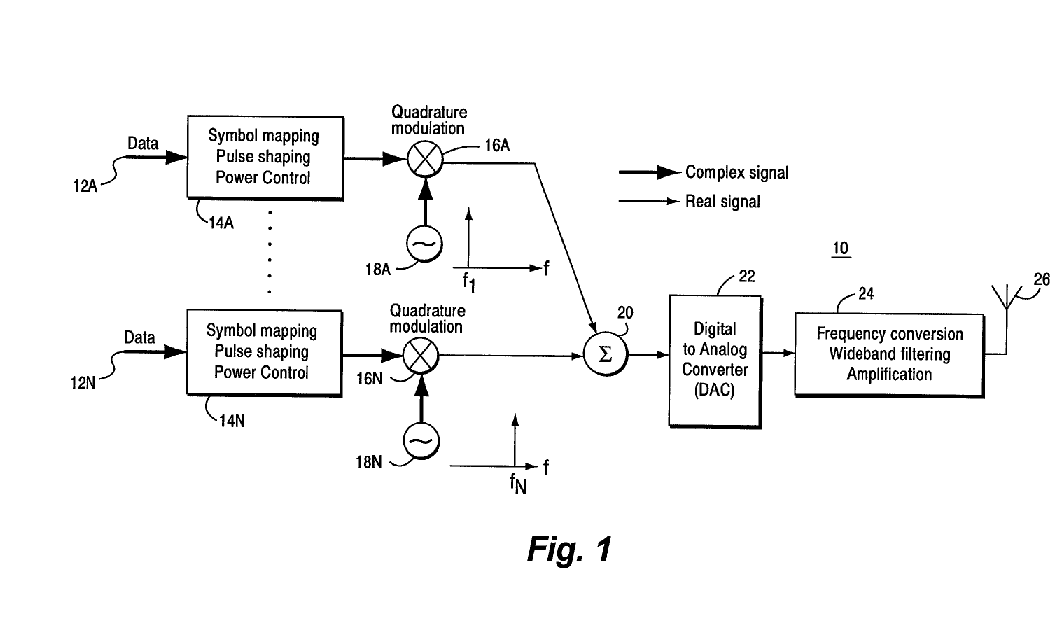

The present invention may be used, for example, in the multicarrier transmitter shown in FIG. 1. However, the present invention is not limited to multicarrier transmitters or multicarrier signals. Instead, the invention may be used in any environment where it is advantageous to reduce the peak-to-average power ratio of a signal.

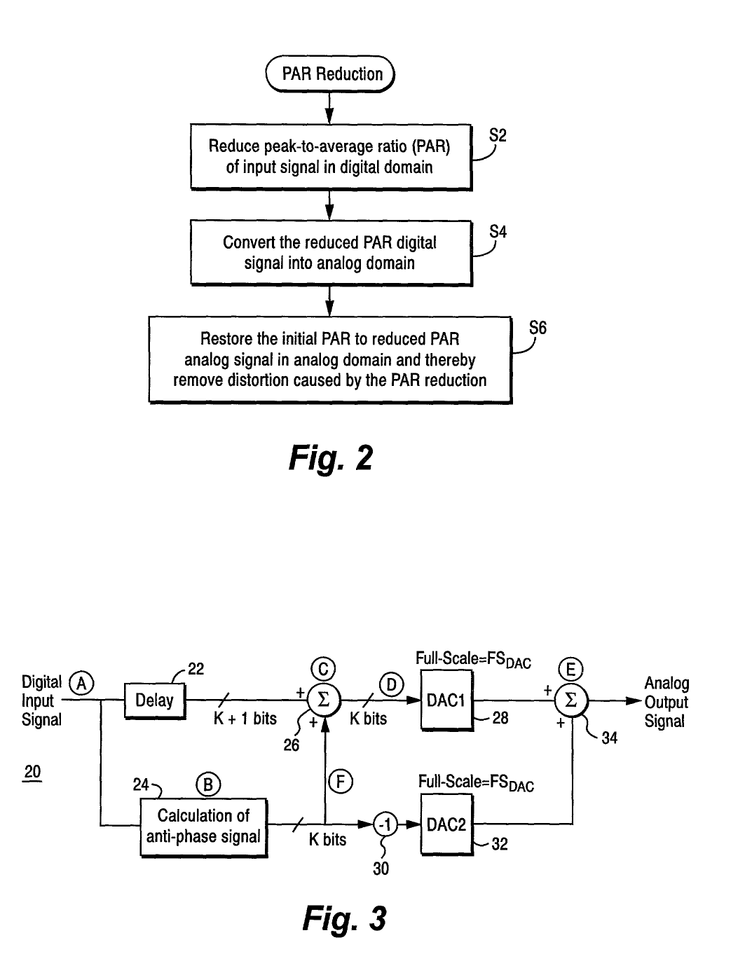

The present invention provides a method for distortionless PAR reduction. This method of reducing PAR can be used to increase the dynamic range of a transmitter and can be achieved without comprising the spectral purity of the transmitted signal. FIG. 2 illustrates a peak-to-average ratio (AR) reduction procedure in accordance with a general embodiment of the invention. The PAR of an input signal received in the digital domain is reduced by any appropriate methodology (step S2). The reduced PAR digital signal is then converted into the analog domain (step S4). Thereafter, the initial PAR of the input signal is restored to the reduced PAR analog signal in the analog domain. As a result, the distortion caused by the PAR reduction is removed (step S6).

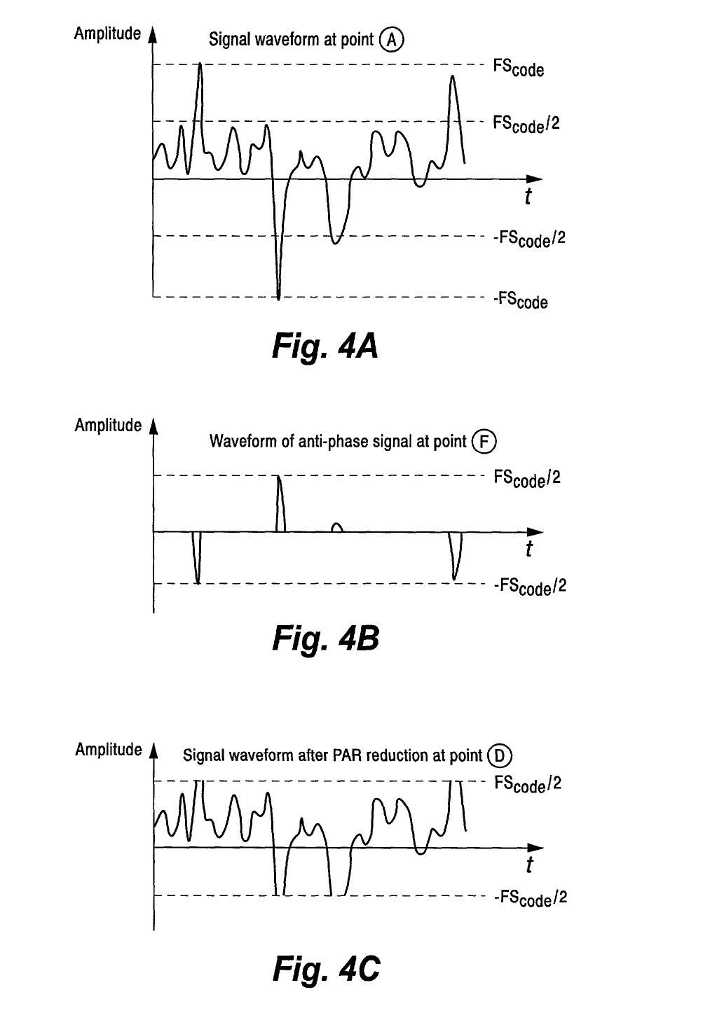

FIG. 3 illustrates a non-limiting example of the present invention. Apparatus 20 provides a digital input signal at point A to a delay 22 and at point B to an anti-phase signal calculator 24. A delayed output is provided to a summer 26 at point C. The anti-phase signal output by the anti-phase calculator 24 is provided at point F to summer 26. The anti-phase signal can be any combination of narrowband and wideband signals that when added with the original digital input signal limits the maximum peak value of the signal to a predefined threshold. The output of summer 26 at point D is a reduced PAR digital waveform that is then converted in a first digital-to-analog converter 28 into an analog signal.

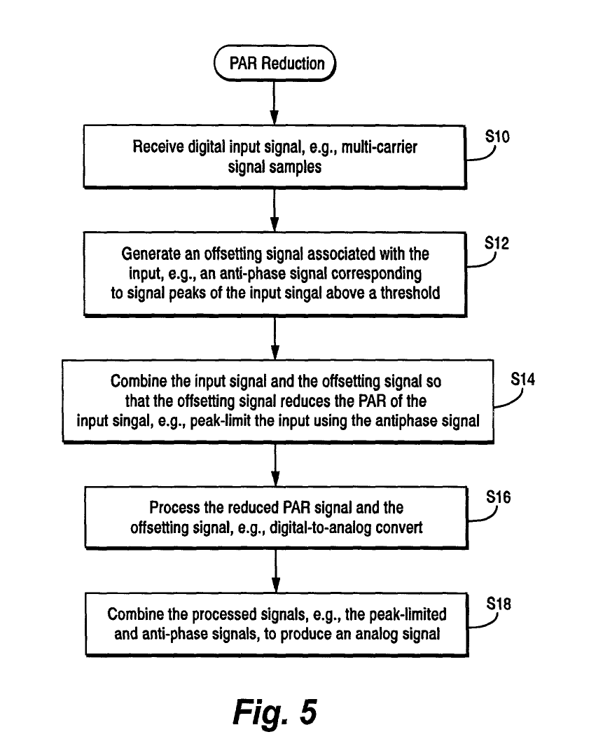

Associated with the example in FIG. 3 are the waveforms shown in FIGS. 4A-4C. FIG. 4A illustrates a graph of a digital input signal at point A. The vertical axis represents the amplitude of the signal waveform while the horizontal axis represents time. The vertical axis is divided into four different amplitudes based on the full-scale value of the first digital-to-analog converter 28. The analog signal level corresponding to the full-scale code (FS_{code}) of the digital-to-analog converter 28 corresponds to a maximum signal amplitude level. FIG. 4B shows the waveform of an anti-phase signal at point F which equals a peak-limited signal corresponding to the magnitude of FS_{code}/2. As shown in FIG. 4C, when the signal waveform at point A and the anti-phase at point F are combined at the summer 26, the resulting or combined waveform at point D is reduced PAR signal waveform whose peaks are limited to a threshold corresponding to the magnitude of FS_{code}/2. In essence, the input signal waveform peaks are clipped at this magnitude. Of course, other thresholds could be employed.

The anti-phase signal is calculated in block 24 during the time delay provided by block 22. The anti-phase signal may be calculated using any appropriate procedure. One example, non-limiting procedure for calculating the anti-phase signal is to detect the part of the signal that exceeds a predefined level as in FIG. 4A. This results in a signal as in FIG. 4B which is then low-pass filtered.

The anti-phase signal is inverted in inverter 30 to make it an in-phase signal, e.g., shifted in phase by 180°. The inversion can be performed in any suitable fashion. One simple way is to reverse the sign of the signal, but other more sophisticated methodologies may be employed. The inverted anti-phase signal is converted into the analog domain using a digital-to-analog converter 32, which is preferably matched with the digital-to-analog converter 28. In other words, the two digital-to-analog converters preferably have the same resolution and analog full-scale output levels.

The reduction in PAR of the digital input signal at point E means that the signal spectrum is distorted by the anti-phase signal. To remove this distortion, the inverted anti-phase signal (the in-phase signal) is summed with the reduced PAR signal at summer 34. If the two signal paths are matched in phase and amplitude, the original input signal is restored without any remaining distortion from the PAR reduction. In other words, the combined signal at point E can be transmitted without distortion.

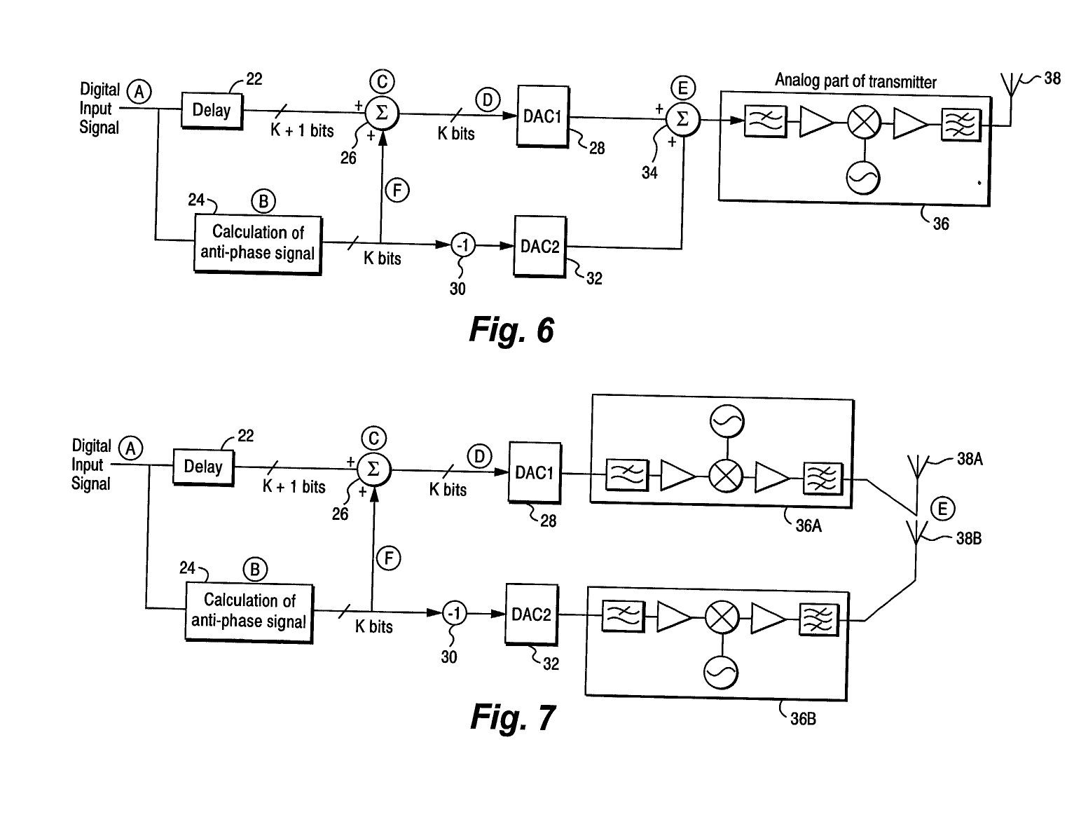

FIG. 5 illustrates in flowchart form an example PAR reduction procedure in accordance with the example embodiment shown in FIGS. 3 and 4. A digital input signal is received in step S10. A non-limiting example of such a digital input signal is a digitally sampled multicarrier waveform. An offsetting signal associated with the input is generated. One example of an offsetting signal is an anti-phase signal that corresponds to the signal peaks of the input signal above a particular threshold but 180° out-of-phase with the input signal peaks (step S12). The input signal and the offsetting signal are combined so that the offsetting signal reduces the PAR of the input signal to a peak-limited value (step S14). The reduced PAR signal and the offsetting signal are then processed (step S16), e.g., digital-to-analog converted. Because of the reduced PAR of the input signal, the dynamic range of the digital-to-analog converter, and any subsequent processing blocks involved before combination with the offsetting signal in the analog domain, should be designed for a higher dynamic range (step S16). Processed reduced PAR and offsetting signals, e.g., the peak-limited and anti-phase signals, are then combined in the analog domain to produce an analog signal (step S18). As described above, this analog combination restores the peak-to-average ratio of the initial input signal and thereby removes distortion added by the PAR reduction process. Any additional processing of the analog signal will require a processing design that accommodates the higher PAR.

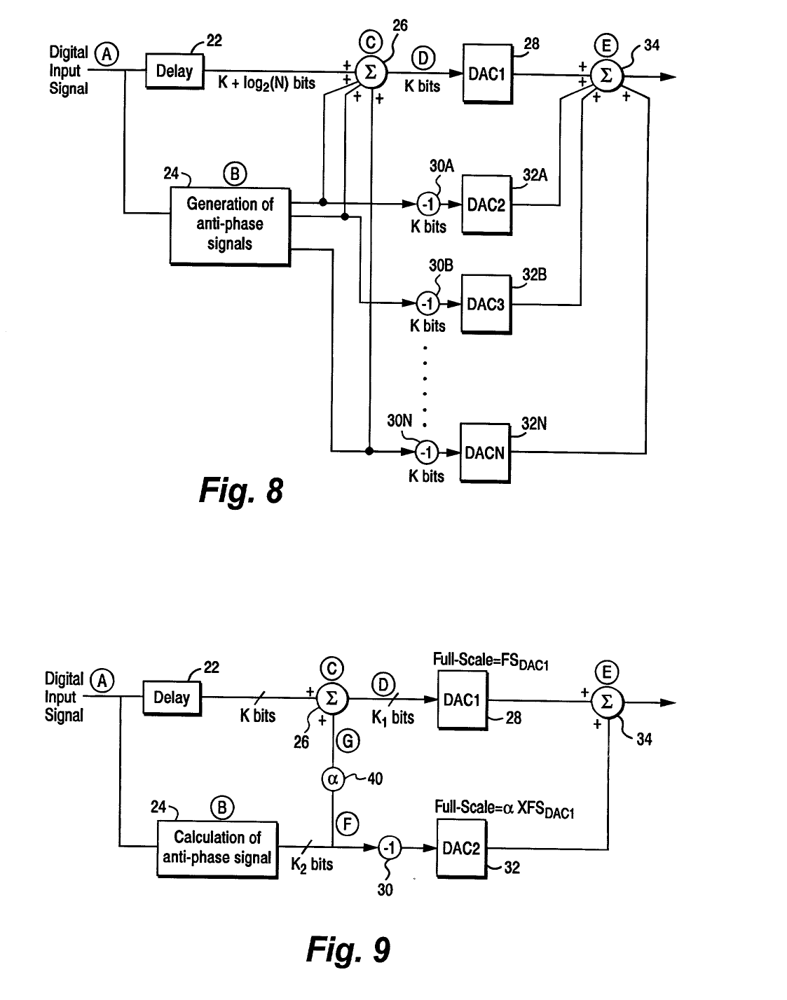

The summation point E of the reduced PAR and offsetting signal may be at different points in the processing/transmitting chain. FIG. 6 illustrates the example embodiment of FIG. 3 with the summation point E directly after conversion by the two digital-to-analog converters 20 and 32. The analog signal output from summer 34 is then provided to an analog portion of the transmitter represented by block 36 coupled to an antenna 38. In this embodiment, the processing components in the analog part of the transmitter 36 must be designed for the restored, higher PAR.

FIG. 7 shows an alternative example embodiment where the summation point E is performed at the air interface. The output of digital-to-analog converters 28 and 32 are processed in two matched analog transmission branches 36A and 36B and transmitted by respective antennas 38A and 38B. The antenna outputs combine to remove the distortion resulting from the reduced PAR The advantage of this embodiment is that the components in the analog transmitter branches 36A and 36B can be designed for the reduced PAR signal. To ensure good phase and gain balance between the two branches over a wide bandwidth, digital calibration techniques may be used, e.g., a measurement receiver may be used. The phase and amplitude should be balanced up to the analog summing junction. Mismatch between the branches results in some distortion. A well-balanced design, e.g., providing the same components on a single chip, is helpful in achieving this end. Additionally, an adaptive phase or an adaptive gain element may be provided to ensure the appropriate balance between branches.

Another advantage of the present invention is the two digital-to-analog converters 28 and 32 can be operated together in a particularly efficient fashion. The first digital-to-analog converter 28 is designed to operate at its full-scale when the signal is being “clipped.” As a result, it generates a substantially constant analog output signal corresponding to its full-scale without producing any significant quantization noise. There is some quantization noise associated with the digital-to-analog conversion in the second digital-to-analog converter 32, which is not operating at a full scale value. However, the combined quantization noise from the digital-to-analog conversion process using the two digital-to-analog converters 28 and 32 is substantially equal to the quantization noise of only one of the digital-to-analog converters, i.e., digital-to-analog converter 32. Although there may be some relatively small thermal noise added from each of the digital-to-analog converters, thermal noise is typically not a significant noise source, particularly relative to quantization noise. As a result, the summation of the outputs of the two digital-to-analog converters at point E permits an improvement in signal dynamic range at the digital-to-analog converter 28 without a corresponding increase in noise/distortion.

The present invention may achieve higher signal-to-noise and distortion by using N matched digital-to-analog converters such as shown in the example, non-limiting embodiment of FIG. 8. Here, the anti-phase signal is mapped to N−1 parallel branches, each branch including an inverter 30A-30N and a digital-to-analog converter 32A-32N. Each branch output is provided to summing node 34. The improvement in signal-to-noise-and-distortion (SINAD) ratio using N digital-to-analog converters DACs) is 20 log N. Further description of this SINAD improvement using N DACs is found in co-pending, commonly-assigned application “Method and Apparatus for Digital-to-Analog Conversion With Improved Signal-to-Noise Ratio,” filed on Sep. 28, 2001.

The present invention may also achieve increases in signal-to-noise-and-distortion ratio using two or more digital-to-analog converters of different resolution and full-scale levels. Referring to the example, non-limiting example embodiment shown in FIG. 9, the resolution of the second digital-to-analog converter 32 is K₂ bits, where K₂ may be larger or smaller than the resolution of the digital-to-analog converter 28 K₁. The anti-phase signal at point F is amplified in the digital domain by “α” so that the desired PAR reduction is achieved at summation at point C. The analog full-scale range of the second digital-to-analog converter 32 is α* FS_{DAC1} to ensure that the anti-phase signals have the correct amplitude at the analog summation point E. In other words, the inverted anti-phase signal is “amplified” by “α” in the analog signal path at point C and as well in the digital path at DAC2 to enable reduction of more than half of the full-scale analog level.

The quantization of the digital-to-analog converter 28 is FS_{DAC1}/2^{K1}, and that of digital-to-analog converter 32 is α* FS_{DAC1}/2^{K2}. If the gain α is compensated by an increased resolution K₂, the quantization noise from the two digital-to-analog converters is the same. However, for a large PAR, the second digital-to-analog converter 32 is active with a low duty cycle, and hence, the average quantization noise is not as much a factor. As a result, a lower resolution digital-to-analog converter may be used to convert the anti-phase signal, and thereby reduce the cost and complexity of the arrangement. This approach allows increased SNR but with just two digital-to-analog converters.

While the present invention has been described with respect to particular example embodiments, those skilled in the art will recognize that the present invention is not limited to those specific embodiments described and illustrated herein. Different formats, embodiments, adaptations besides those shown and described, as well as many modifications, variations and equivalent arrangements may also be used to implement the invention. Although the present invention is described in relation to preferred example embodiments, it is to be understood that this disclosure is only illustrative and exemplary of the present invention. The scope of the invention is defined by the appended claims.

What is claimed:

1. A method for reducing a peak-to-average ratio (PAR) of a signal, comprising:
(a) receiving a input signal;
(b) generating an offsetting signal associated with the input signal;
(c) combining the input signal and the offsetting signal so that the offsetting signal reduces the PAR of the input signal to produce a combined signal;
(d) processing the combined signal and the offsetting signal; and
(e) combining the processed combined signal and the processed offsetting signal.

2. The method in claim 1, wherein the input signal is a multi-carrier signal.

3. The method in claim 1, wherein the offsetting signal is an anti-phase signal.

4. The method in claim 1, wherein the processing includes converting the combined signal and the offsetting signal from digital form into analog form and the analog combined signal and the analog offsetting signal are combined in step (e) to generate an analog combined signal.

5. The method in claim 4, further comprising:
transmitting the analog combined signal.

6. The method in claim 5, further comprising:
performing analog processing on the analog combined signal before transmission.

7. The method in claim 5, wherein the processing includes analog processing the combined signal and the offsetting signal before the combining and transmission.

8. The method in claim 4, wherein the offsetting signal is converted into analog form using plural digital-to-analog converters.

9. The method in claim 4, wherein the combined signal and the offsetting signal are each converted into analog form using a respective digital-to-analog converter, and wherein each digital-to-analog converter has substantially the same characteristics.

10. The method in claim 4, wherein the combined signal and the offsetting signal are each converted into analog form using a respective digital-to-analog converter, and wherein each digital-to-analog converter has different characteristics.

11. A method of reducing a peak-to-average ratio (PAR) of a signal, comprising:
receiving a digital input signal;
formulating an anti-phase signal for the input signal;
combining the input and anti-phase signals to produce a peak-limited digital signal;
converting the peak-limited digital signal in a first digital-to-analog converter into a peak-limited analog signal;
converting the anti-phase digital signal in a second digital-to-analog converter into an anti-phase analog signal; and
combining the peak-limited and anti-phase analog signals to produce a combined analog signal.

12. The method in claim 11, further comprising:
changing a sign of the anti-phase signal or inverting the anti-phase signal before combining the peak-limited and anti-phase analog signals.

13. The method in claim 11, wherein the anti-phase signal limits the input signal peak to a threshold associated with a range of the first digital-to-analog converter.

14. The method in claim 13, wherein threshold corresponds to a full scale range of the first digital-to-analog converter such that the peak-limited analog signal does not contribute substantial quantization noise from the conversion in the first digital-to-analog converter to the combined analog signal.

15. The method in claim 14, wherein a dynamic range associated with the digital-to-analog conversion of the input signal using the first and second digital-to-analog converter is greater than using only a single digital-to-analog converter.

16. The method in claim 11, wherein the combining removes distortion caused by peak-limiting the input signal.

17. The method in claim 11, further comprising:
transmitting the combined analog signal.

18. The method in claim 17, further comprising:
performing analog processing on the combined analog signal before transmission.

19. The method in claim 17, further comprising:
analog processing the peak-limited analog signal and the anti-phase analog signal before the combining and transmission.

20. The method in claim 11, wherein the first and second digital-to-analog converters have substantially the same characteristics.

21. The method in claim 11, wherein the first and second digital-to-analog converters have different characteristics.

22. A method, comprising:
reducing in a digital domain a peak-to-average ratio (AR) of a signal having an initial PAR;
converting the reduced PAR digital signal into the analog domain to provide a reduced PAR analog signal; and
removing distortion in the reduced PAR analog signal caused by the PAR reducing step in the analog domain.

23. The method in claim 22, wherein the removing step includes restoring the initial PAR from the reduced PAR analog signal.

24. The method in claim 22, wherein the PAR reducing step is accomplished using an anti-phase signal to offset peaks of the signal in the digital domain.

25. The method in claim 24, further comprising:
transforming the anti-phase signal into an in-phase signal;
converting the in-phase signal into the analog domain; and
wherein the restoring step includes combining the analog in-phase signal with the reduced PAR analog signal.

26. Apparatus for reducing a peak-to-average ratio (PAR) of an input signal, comprising:
first electronic circuitry configured to generate an offsetting signal associated with the input signal;
a first combiner configured to combine the input signal and the offsetting signal so that the offsetting signal reduces the PAR of the input signal to produce a combined signal;
second electronic circuitry configured to process the combined signal and the offsetting signal; and
a second combiner configured to combine the processed combined signal and the processed offsetting signal.

27. The apparatus in claim 26, wherein the input signal is a multi-carrier signal.

28. The apparatus in claim 26, wherein the offsetting signal is an anti-phase signal.

29. The apparatus in claim 26, wherein the second electronic circuitry includes first and second digital-to-analog converters for converting the combined signal and the offsetting signal, respectively, into analog form, and the second combiner is configured to combine the analog combined signal and the analog offsetting signal to generate an analog combined signal.

30. The apparatus in claim 26, further comprising:
third electronic circuitry configured to process the analog combined signal before transmission.

31. The apparatus in claim 26, further comprising:
third electronic circuitry configured to process in the analog domain the combined signal and the offsetting signal before the combining.

32. The apparatus in claim 26, wherein the first and second digital-to-analog converters have substantially the same characteristics.

33. The apparatus in claim 26, wherein the first and second digital-to-analog converters have substantially different characteristics.

34. Apparatus for reducing a peak-to-average ratio (AR) of an input signal, comprising:
first electronic circuitry configured to receive a digital input signal and to formulate an anti-phase signal for the input signal;
a first combiner configured to combine the input and anti-phase signals to produce a peak-limited digital signal;
a first digital-to-analog converter configured to convert the peak-limited digital signal into a peak-limited analog signal;
a second digital-to-analog converter configured to convert the anti-phase digital signal into an anti-phase analog signal; and
a second combiner configured to combine the peak-limited analog signal and the anti-phase analog signal.

35. The apparatus in claim 34, further comprising:
processing circuitry configured to change a sign of the anti-phase signal or to invert the anti-phase signal before combining the peak-limited and anti-phase analog signals.

36. The apparatus in claim 34, wherein combining the input and anti-phase signals limits the input signal peak value to a threshold associated with a range of the first digital-to-analog converter.

37. The apparatus in claim 36, wherein threshold corresponds to a full scale range of the first digital-to-analog converter such that the peak-limited analog signal does not contribute substantial quantization noise from the conversion in the first digital-to-analog converter to the combined analog signal.

38. The apparatus in claim 37, wherein a dynamic range associated with the digital-to-analog conversion of the input signal using the first and second digital-to-analog converters is greater than using only a single digital-to-analog converter.

39. The apparatus in claim 34, wherein the combining removes distortion caused by peak-limiting the input signal.

40. The apparatus in claim 34, further comprising:
analog processing circuitry configured to perform analog processing on the combined analog signal.

41. The apparatus in claim 34, further comprising:
analog processing circuitry configured to perform analog processing on the peak-limited analog signal and the anti-phase analog signal before the combining.

42. The apparatus in claim 34, further comprising:
a third digital-to-analog converter configured to convert the anti-phase digital signal into an anti-phase analog signal,
wherein the first electronic circuitry is configured to map the anti-phase signal to the second and third digital-to-analog converters and to the first combiner, and
wherein the second and third digital-to-analog converters provide corresponding outputs to the second combiner.

43. The apparatus in claim 34, wherein the first and second digital-to-analog converters have substantially the same characteristics.

44. The apparatus in claim 34, wherein the first and second digital-to-analog converters have different characteristics.
